(19) United States
(12) Patent Application Publication
(10) Pub. No.: US 2005/0010381 A1
(43) Pub. Date: Jan. 13, 2005

(54) Fast computer algorithms for solving differential equations

(76) Inventor: Inge Maudal, Sugarloaf, CA (US)

Correspondence Address: Inge Maudal, P.O. Box 1058, Sugarloaf, CA, 92386, US

(21) Appl. No.: 10/884,217

(22) Filed: Jul. 2, 2004

Related U.S. Application Data
(60) Provisional application No. 60/485,282, filed on Jul. 3, 2003.

(51) Int. Cl. G06F 17/10

(52) U.S. Cl. 703/2

(57) ABSTRACT

The invention consists of means which computes the numerical solution of an interconnected system of first order differential equations in a single computational pass. The method in effect treats the digital computer as a close approximation to an analog computer whose solutions are instantaneous. This is in contradistinction to the prior art regarding digital computer solutions of first order differential equations that utilize repetitive computational passes over the same time interval to obtain numerical solutions, and which further generates estimates of future values extrapolated from past values of state variables. The invention inserts an auxiliary function existing between, and at, the times marking the computational intervals. The invention rests on three postulates regarding the auxiliary function: a first postulate expands on the Euler formulation of the solution of a differential equation by including the unknown sought after state variable in an expanded Euler formulation. a second postulate introduces an integratable auxiliary equation existing in the computational interval that is bounded by successive sample times. Parameters of the auxiliary functions are determined by using boundary values of the system state equations, a third postulate separates the system auxiliary equation into at least a first and a second part. A first part is the set of independent solutions of each first order differential equation within a system of first order differential equations; a second part incorporates the interconnections between the first order solutions of the state variables, and. a fourth postulate adds to the above by choosing the state equation for each independent first order differential equation, in a system of differential equations, as the integratable auxiliary equation; furthermore choosing the solution of the chosen auxiliary equations as the definite integral of each auxiliary equation; and furthermore obtaining the overall system state via simultaneous solution of the resulting system of algebraic

### BACKGROUND OF THE INVENTION

1. Field of the Invention

This invention relates to discrete and machine implemented solutions of linear differential equations performed at discrete times. The time interval between computations is primarily set by the speed of the machine. The invention addresses the distinction between a linear mathematical solution and discrete solutions existing within a machine. The linear solution exist and is known at all time; the discrete solution is known and determined only at the discrete instants of actual numerical computations.

The machine of choice is a digital computer with associated software; the solutions are repeated numerical values of the solution rather than abstract mathematical constructs. The lack of knowledge within the intervals between computations requires complex and time consuming computational and estimation techniques in the prior art.

Terminology:

Equation: A statement of true equality, e.g. a mathematical equation;
Algorithm: A relationship of variables and constants that may be modified to support algebraic digital computer operations.
Replacement Statement: An instruction in a digital computer which replaces the contents in one memory address with the final result of a computational algorithm.
   Notation: Variables associated by time of computation, such as the nth computational sample time, are generally identified in subscripted notation, such as tₙ,tₙ₊₁,xₙ, etc.. When combined with indexes denoting time as well as individual members in a matrix, time may be noted in pre-subscripts and position in the matrix in post-subscripts , i.e. ₙ₊₁x₁.

2. Prior Art

The behavior of a simple real world system is originally stated in mathematics as the linear differential equation
x′=ax+g(t) (1)
where t denotes time, the independent variable,
x denotes the state variable, a dependant variable,
x′ denotes the derivative with respect to time of the dependent variable, itself a state variable,
a denotes a constant, and
g(t) denotes an input.

A solution of equation 1 is well known in mathematics as
x=ce^{at}+b(t) (2)
where b (t) is the contribution by the input g(t) and c a constant. Equation 2 represents a mathematical solution of the differential equation subject to external inputs. It is valid for all times. The equations 1 and 2 are generally labeled the state equations of a physical system.

Analog computers readily and faithfully implement the differential equation 1. The instantaneous and continuous values of the state variables in equation 1 are completely and continuously manifest at all times. Therefore, the solution is also instantaneous and accurate at all times. The solution is precisely described by equation 2. Several differential equations 1 connected into a complete interacting system retain the instantaneous and faithful characteristics of the single differential equation 1.

The digital computer representation of equation 1, on the other hand, is limited by the inherent discrete nature of a digital computers. Thus, the equation 1 exists internally in the computer only at the specific times of actual computation; the values of the state variables in equation 1 are known only at the precise time of computation. As a result, the values of equation 1 between the computation intervals are not known. The difficulties of discreteness are magnified when a multiplicity of first order differential equations are connected into an overall complex system.

The discrete nature of solutions with a digital computer is illustrated by Euler's formulation of a differential equation. The formulation excludes inputs. In its simplest form the Euler formulation is:
xₙ₊₁=xₙ+δ(axₙ) (3)
where
the subscript n denotes a past time tₙ,
the subscript n+1 denotes the current computational time tₙ₊₁,
δ is the computational time interval, i.e. δ=tₙ₊₁-tₙ,
xₙ is the value of x at time tₙ, usually a past time point,
xₙ₊₁ is the value of x at time tₙ₊₁, usually the present time,
(axₙ) is the value of the differential x′ₙ at time tₙ, and
δ (ax) denotes rectangular integration

It is important to note that the values of xₙ and xₙ₊₁ in expression 3 are only true at the specific times tₙ and tₙ₊₁. Nothing (or very little) is known of the actual behavior of the function within the computational increment δ. Expression 3 thus illustrate the difficulty of the discrete nature of the digital computer implementation; the derivative of x at the time of computation t=tₙ₊₁, i.e. (axₙ₊₁) is unknown and therefore not available. It simply has not yet been computed.

The Euler formulation of a first order differential equation 1 therefore must make do with the last known value of x, i.e. xₙ. The second term in expression 3 consequently represents a simple rectangular integration; the derivative of x is assumed to be constant with the value of x saved at t=tₙ rather than the integral solution in equation 2. The computational result is therefore only an estimate of the real thing, in reality a questionable guess.

The current state of the art utilizes more accurate computational and estimation methods than Euler's formulation. Although these methods may be highly complex as well as sophisticated, the methods are still bound by the limitation of having to estimate present values of variables at time t=tₙ₊₁ based on extrapolation of knowledge of stored past values computed previously at time t=tₙ.

Examples of numerical methods known in the state of the art are variations of the Runge-Kutta methods, the Richardson extrapolation methods, and the predictor-corrector methods.

A fourth order Runge-Kutta example follows. The method makes four intermediate estimates computed at times tₙ, tₙ, +Δ/2, tₙ, +Δ/2, and tₙ+Δ. This requires four independent calculation for each computational interval of time. In addition the four results are finally averaged in a Taylor series computation.

Let kᵢ be the rectangular integration at respective computational times. Then

$$\begin{matrix}{k}_{1} = δ a ( {x}_{n} ) \\ {k}_{2} = δ a ( {x}_{n} + \frac{{k}_{1}}{2} ) \\ {k}_{3} = δ a ( {x}_{n} + \frac{{k}_{2}}{2} ) \\ {k}_{4} = δ a ( {x}_{n} + {k}_{3} )\end{matrix} \qquad ( 4 )$$

The final result is the average of the weighted sum of the intermediate calculations. Note that the result suffers from both an approximation to the integral, i.e. rectangular integration, as well as an estimate of the answer. Thus

$${x}_{n + 1} = {x}_{n} + \frac{{k}_{1}}{6} + \frac{{k}_{2}}{3} + \frac{{k}_{3}}{3} + \frac{{k}_{4}}{6} \qquad ( 5 )$$

Algorithms 4 and 5 must be computed repetitively for each computer interval. It is clear that the computational burden of this method is high, as are all estimation methods.

### SUMMARY OF THE INVENTION

The invention consists of means which computes the numerical solution of an interconnected system of first order differential equations in a single computational pass. The method in effect treats the digital computer as a close approximation to an analog computer whose solutions are instantaneous. This is in contradistinction to the prior art regarding digital computers solutions of first order differential equations that utilizes repetitive computational passes over the same time interval to obtain numerical solutions, and that additionally generates estimates of future values extrapolated from past values of state variables.

The invention rests on three postulates valid as to signals between, and at, computational intervals.

The first postulate expands on the Euler formulation of the solution of a differential equation; this invention includes the unknown sought after state variable in formulating an algorithm solving the differential equation. Because the computational values are discrete, the algorithm is based on algebraic equations subject to simultaneous solution techniques of algebraic equations;

The first embodiment, infra, illustrates the simplest form of this postulate.

The second postulate permits formulation of integratable auxiliary equations existing in the computational interval bounded by successive sample times. The defined boundary conditions thus include both the unknown value of the state variable at t=tₙ₊₁ as well as the known, i.e. saved, value at t=tₙ. The values of the boundary conditions are defined by the system state equations; these boundary values are then used to define parameters of the auxiliary algorithm. The integrated auxiliary algorithm thus closely matches the state equation.

Even though the state variable xₙ₊₁ at t=tₙ₊₁ is an unknown, it may be included in formulating an integratable auxiliary equation. The method computes coefficients of an chosen auxiliary function based on values at the boundary conditions x=xₙ and x=xₙ₊₁. The values at the boundaries are obtained from the actual state equations. After integration of the auxiliary equation, this formulation in effect converts the differential equation into an ordinary algebraic equation with one unknown.

Because the integrated auxiliary equation is a mere algebraic equation, the unknown value, xₙ₊₁, may be moved to the left hand side of the equation. The isolated value, i.e. solution of the algebraic equation, forms the basis for algorithms that may be computed directly.

The second embodiment illustrate this postulate.

The third postulate separates the system auxiliary equation into at least a first and a second part. A first part is the set of independent solutions of each first order differential equation within a system of first order differential equations; a second part incorporates the interconnections between the solutions of the first order differential equations. The first part are closed form solutions of the independent first order equations; the second part is an auxiliary equation describing the interconnectedness which form the physical system under consideration.

The third embodiment generally illustrates this postulate.

The fourth postulate, in a system of first order differential equations (DEs), adds to the above by choosing the state equation for each independent DE as the integratable auxiliary equation. The resulting integrated auxiliary equation is next defined as the solution of the chosen auxiliary equation.

We note that the solution of each DE will have a complementary term, i.e. the solution of the homogeneous equation; this is present irrespective of inputs. We therefore postulate that the nature of signals within the system is uniquely defined by each individual DE, i.e. each DE is in effect a signal source. These signals, labeled source signals, are the familiar exponential terms defined by the homogeneous equations. The total signal within the system therefore comprises a collections of source signals.

We therefore obtain solutions of each DE comprising a complementary solutions with added terms that are the particular solutions caused by inputs. Evaluated at the boundaries of the sample intervals, these solutions are mere algebraic equations.

The solutions are general in that the coefficient to the signals are unknown. We therefore solve for these coefficients by obtaining the simultaneous solutions of the set of algebraic equations within the overall system.

### OBJECTS OF THE INVENTION

It is a principal object of this invention to obtain digital computer algorithms for numerical solutions of differential equations that approximates the speed and fidelity of analog computers.

It is a further principal object of this invention to obtain a more stable computer algorithms for numerical solution of differential equations.

It is a further principal object of this invention to obtain a more accurate computer algorithms for numerical solution of differential equations.

It is further an object of this invention to improve “real time” performance when a digital computer controls the operation of external hardware systems.

### DETAILED DESCRIPTION OF PREFERRED EMBODIMENTS

A First Embodiment

The Euler representation of the differential equation is shown in equation 3 above. The past value of x, i.e. xₙ, is known; the value of x at the present time, i.e. xₙ₊₁, is unknown.

If we now consider equation 3 at the boundaries, i.e. at time tₙ and at time tₙ₊₁, we note that the equations represent fixed values, i.e. constants. When we now insert the values for x at these boundary conditions we note that the equation is no longer a differential equation but a mere algebraic equation. We can now rewrite the equation 3 in terms of the boundary conditions. Thus:
xₙ₊₁=xₙ+δ(axₙ₊₁) (6)

We still do not know the value of xₙ₊₁, However, equation 6 is a simple algebraic equation and we can solve for xₙ₊₁. Reordering equation 6 we have

$${x}_{n + 1} = \frac{1}{1 - δ a} {x}_{n} \qquad ( 7 )$$

Equation 7 represents a simple system described by a single differential equation and is the simplest embodiment of the invention. However, the method holds equally true for a general system of equations. In this case the equation may be expressed in matrix form. The matrix form is illustrated in subsequent developments.

This formulation illustrates the first postulate.

A Second Embodiment

Expressed in a Single Equation:

Consider the first order differential equation 1 above as a starting point in describing this invention. We posit an auxiliary function of time existing continuously in the time interval between the discrete times of computations. Thus
ƒ′(t)=b+ct (8)
where f′ is df/dt., b and c are constants, and t is time. So far we are considering an absence of inputs. Integrating 8 we have

$$f ( t ) = d + bt + \frac{c}{2} {t}^{2} \qquad ( 9 )$$

where d is a constant of integration. Equation 9 is now our approximation of the variable x in the time increment between computations. We determine the coefficients of equations 8 and 9 by evaluating the functions at the boundary conditions.

Setting tₙ=0 at the beginning of the computer interval and tₙ₊₁=δ at the end of the computing interval, we replace the values of 8 and 9 at these times. Simultaneously we posit that, at the boundary conditions, the auxiliary functions closely represents our state equations, i.e. f′(t)=x′ and f(t)=x. We may now state our necessary boundary conditions.
x′ₙ=b
xₙ=d
xₙ₊₁=b+cδ (10)

We solve for the coefficients in 10 and substitute into equation 9 with tₙ₊₁−tₙ=δ and get

$${x}_{n + 1} = {x}_{n} + δ {x}_{n}^{′} + \frac{δ}{2} ( {x}_{n + 1} - {x}_{n}^{′} ) \qquad ( 11 )$$

We note at this point an important aspect of this invention. Even though equation 11 contains the derivative terms x′ₙ and x′ₙ₊₁, these terms are values of the derivatives evaluated at the precise times tₙ and tₙ₊₁. The terms are therefore constants, and
x′ₙ=axₙ
and
x′ₙ₊₁=axₙ₊₁ (12)
are also constants.

We are therefore dealing with algebraic equations rather than differential equations and may freely substitute the values of algorithm 12 directly into algorithm 11. Then

$${x}_{n + 1} = {x}_{n} + δ a {x}_{n} + \frac{δ}{2} ( a {x}_{n + 1} - a {x}_{n} ) \qquad ( 13 )$$

For comparison purposes we rearrange 13 into a form similar to Euler's formulation in equation 3. Then

$${x}_{n + 1} = {x}_{n} + δ a \frac{( {x}_{n} + {x}_{n + 1} )}{2} \qquad ( 14 )$$

The auxiliary function of equation 8 therefore results in trapezoidal integration, thus also an approximation to a mathematical solution of the differential equation. However, it a far improvement over Euler's method and over algorithms that base their algorithms on rectangular integration.

Neither equation 13 nor equation 14 produce a solution. Relying on simple algebra we re-order equation 14 to solve for the unknown value, xₙ₊₁;

$$( 1 - \frac{δ}{2} a ) {x}_{n + 1} = ( 1 + \frac{δ}{2} a ) {x}_{n} \qquad ( 15 )$$

In the case of a system characterized by a single differential equation, we re-order 15 into a simple algorithm for computing the numerical values of xₙ₊₁ at the end of each computation interval:

$${x}_{n + 1} = \frac{( 1 + \frac{δ}{2} a )}{( 1 - \frac{δ}{2} a )} {x}_{n} \qquad ( 16 )$$

Replacement statement 16 governs the means whereby the software computes numerical values which represents the solution to the original differential equation. We note that the desired value results after a single computation per integration interval.

It is a significant improvement over Euler and is sufficient in systems requiring moderate accuracy.

Expressed in Matrix Form:

We next adapt the second embodiment to a general system defined by a set of N first order differential equations. We express the system in matrix form:
(X′)=[A](X) (17)
where (X′) and (X) are 1×N column matrices and [A] is a N×N square matrix.

The representation of the auxiliary function in matrix form is
(F′)=[B]+[C]t (18)
and

$$( F ) = [ D ] + [ B ] t + \frac{1}{2} [ C ] {t}^{2} \qquad ( 19 )$$

Combining 17, 18, and 19 and evaluating at the boundaries we have,
[A](Xₙ)=[B]
(Xₙ)=[D]
[A](Xₙ₊₁)=[B]+δ[C] (20)

Having algebraic equations we combine 19 and 20 we may isolate the unknown column matrix (Xₙ₊₁):

$$[ [ I ] - \frac{δ}{2} [ A ] ] ( {X}_{n + 1} ) = [ [ I ] + \frac{δ}{2} [ A ] ] ( {X}_{n} ) \qquad ( 21 )$$

where [I] is the identity matrix. The unknown column matrix (Xₙ₊₁) is obtained by a matrix multiplication using the inverse matrix of the left hand matrix in algorithm 21. Thus

$$( {X}_{n} ) = {[ [ I ] - \frac{δ}{2} [ A ] ]}^{- 1} [ [ I ] + \frac{δ}{2} [ A ] ] ( {X}_{n} ) \qquad ( 22 )$$

Means for finding the inverse matrix, and for manipulating matrices are available in prior art. Thus,
(Xₙ₊₁)=[M](Xₙ) (23)

Replacement statement 23 represents the product of the matrix multiplication in expression 22, with [M] representing the resulting matrix. The matrix [M] is often referred to as the propagation matrix.

A Higher Order Auxiliary Function:

Accuracy of the invention may be enhanced by increasing the order of the auxiliary function. We expand the auxiliary function to a quadratic function of time. The third derivative of the differential equation is now also included in order to provide an additional equation to permit the computations of the additional constants of the auxiliary function. Then

$$\begin{matrix}( {F}^{″} ) = & & ( C ) + 2 & ( D ) t + 3 & ( E ) t {t}^{2} \\ ( {F}^{′} ) = & ( B ) + & ( C ) t + & ( D ) {t}^{2} + & ( E ) {t}^{3} \\ ( F ) = ( G ) + & ( B ) t + \frac{1}{2} & ( C ) {t}^{2} + \frac{1}{3} & ( D ) {t}^{3} + \frac{1}{4} & ( E ) {t}^{4 }\end{matrix} \qquad ( 24 )$$

Substitution at the boundary conditions yields
(F″ₙ)=(C)
(F′ₙ)=(B)
(Fₙ)=(G)
(F″ₙ₊₁)=(C)+2δ(D)+3δ²(E)
(F′ₙ₊₁)=(B)+δ(C)+δ²(D)+δ³(E)

We again posit that the auxiliary function and the state function are equal at the boundary points. Then,
(F′ₙ)=[A](Xₙ)
(F′ₙ₊₁)=[A](Xₙ₊₁)
(F″ₙ₊₁)=[A][A](Xₙ)
(F″ₙ₊₁)=[A][A](Xₙ₊₁) (26)

Combining algorithms 24, 25, 26, and isolating the column matrix (Xₙ₊₁) as before, we have

$$[ [ I ] - \frac{δ}{2} [ A ] + \frac{{δ}^{2}}{12} [ A ] [ A ] ] ( {X}_{n + 1} ) = [ [ I ] + \frac{δ}{2} [ A ] + \frac{{δ}^{2}}{12} [ A ] [ A ] ] ( {X}_{n} ) \qquad ( 27 )$$

By pre-multiplying by the inverse of the left hand matrix we solve for the unknown column matrix

$$( {X}_{n + 1} ) = {[ [ I ] - \frac{δ}{2} [ A ] + \frac{{δ}^{2}}{12} [ A ] [ A ] ]}^{- 1} [ [ I ] + \frac{δ}{2} [ A ] + \frac{{δ}^{2}}{12} [ A ] [ A ] ] ( {X}_{n} ) \qquad ( 28 )$$

or
(Xₙ₊₁)=[M](Xₙ) (29)

Algorithm 29, the propagation algorithm, governs the means whereby the computer calculates the value of the state variables in each successive integration interval. Employed in the context of a computer algorithm, the algorithm 29 is a replacement statement ordering the flow of data between computer memory locations and external hardware entities.

Note that the matrix [M] is pre-calculated and thus requires a single calculation.

A Third Embodiment

This embodiment builds on the third postulate underlying this invention while also including the first two postulates. The overall system is separated into two sets, a first set comprise elements and a second set comprise auxiliary equations.

The elements consist of independent first order differential equations. Unforced, they each yield a unique mathematical closed form solution; this is the familiar complementary solution of equation 2 above and 37 below. The complementary solutions retain their exponential form throughout the overall system. We will refer to elements yielding such solutions as source elements and to the solutions as source exponentials. These elements are equivalent to integrators of analog computers.

The second set consist of an array of interconnections between the first order elements, thus forming a coupled, overall system. Solutions of the coupled system is obtained via auxiliary equations representing the interconnections between the elements. These interconnections do not change the basic form of the source exponentials generated by the source elements.

The following develops the separation of sets, obtains closed form solutions of the first order differential equations sets, and derives an auxiliary interconnecting algorithm.

Separation of the Sets:

We separate the independent solutions of the set of first order equations from the coupled system. The nomenclature below indicates capitalized \dot{X} and X as column matrices, [A] or A as a square matrix, and lower case [a] or a as the diagonal matrix components of [A]. Subscripts denoting positions of elements in the matrices are implicit in the notation. Then, starting with the basic state equation,
\dot{X}=[A]X (30)
we separating the sets as follows,
\dot{X}=[[A−a]+[a]]X (31)

The general solution for X is then
X=e^{[[A-a]+[a]]t}X0 (32)
where the addendum 0 denote values existing at times t=0. Changing its form we have
X=e^{[A-a]t}e^{[a]t}X0 (33)

The term e^{[a]t}, where the exponent is a square matrix, is generally also a square matrix. However, in this case the matrix [a] is a diagonal matrix; the overall term therefore reduces to a column matrix. The resulting column matrix is therefore the closed form solutions of the uncoupled first order equations, or (expᵢ(aᵢᵢt)X0ᵢ)ᵢ. This may be easily implemented in digital computer algorithm.

The term e^{[A-a]t} are the interconnecting terms and are interdependent with the first order terms; they are not easily responsive to solution via digital computer algorithms because they are not independent. We replace these terms with an auxiliary function matrix [C].

Then
Xᵢ=[C](expᵢ(aᵢᵢt)X0ᵢ) (34)

We expect that the auxiliary function will direct inputs to given elements from source elements. These inputs will have exponential forms as well as constants, however, we expect no modification to the exponential form of the source element. For this reason we expect the auxiliary function to be relatively simple. The auxiliary function [C] should therefore be manageable.

Justification for Separation of Sets.

When a source element is acted on by a multiplicity of inputs which are themselves source exponentials, the solution (result) will retain the form of the individual inputs. Each element will therefore ultimately contain a summation of all first order source exponentials.

Additionally, the elements will generally also incorporate signals generated by inputs originating outside the system. We anticipate that the auxiliary function may be different relative to these inputs. This is illustrated below by solutions using the method of undetermined coefficients.

In a short review, the method of undetermined coefficients refers to solutions of a differential equation, DE, subjected to inputs that are themselves solutions of corresponding differential equations. Exponential terms as well as constants are members of this class of inputs. The first part of the method finds a complimentary solution, xc, of the unforced differential equation, i.e. no inputs. The solutions xc constitute the source exponentials. The second part finds additional solutions reflecting the forced DE, i.e. a DE having inputs. This part yields particular solutions, xp, wherein xp retains the form of the corresponding input. The complete solution is thus
x=xc+xp (35)

We indicate a single differential equation by applying lower case symbols for the state variable x, xc, xp, and for the coefficient a and α.

Expressed in operational notation, the homogeneous differential equation, i.e. unforced by inputs, is
(s−a)x=0 (36)
where s represents the differential operator d/dt. The zero on the right hand side of the equal sign denote the absence of any input or forcing functions. Then, by inspection,
xc=αe^{at} (37)
is the complementary solution of 36 and is the source exponential. The constant α is an as yet undetermined. In the simple case of 37, the constant α simply reflect an initial condition on x. Its value will ultimately depend on system constraints and on inputs to the system of first order differential equations.

Consider next the fate of an exponential input. Assume elements x₁ has an input from element x₂. The value x₂ is the solution of a DE; x₂ therefore represents a source element. Then
(s−a₁₁)x₁=a₁₂(α₂₂e^{a}^{₂₂}^{f}) (38)

The method of undetermined coefficients seeks to reduce the right hand side of 38 to zero thereby converting the equation 38 to a homogeneous equation which we can solve by inspection.

Because the exponential e^{a}^{₂₂}^{t} in equation 38 is a known solution to a differential equation of the form of equation 36 we multiply equation 38 with a suitable operand. Then
(s−a₂₂)(s−a₁₁)x₁=0 (39)

By inspection we have a solution of the homogeneous equation 39 in the form of
x₁=α₁₁e^{a}^{₁₁}^{t}+ce^{a}^{₂₂}^{t} (40)

From 37 we have
xc₁=α₁₁e^{a}^{₁₁}^{t} (41)

Therefore
xp₁=ce^{a}^{₂₂}^{t} (42)
is a particular solution. The constant c in 40 and 42 is unknown, yet not arbitrary. We solve for c combining 38 and 42. Then
(s−a₁₁)(ce^{a}^{₂₂}^{t})=a₁₂(α₂₂e^{a}^{₂₂}^{t}) (43)

Executing the operation comprising 43 we solve for c,

$$c = \frac{{a}_{12}}{( {a}_{22} - {a}_{11} )} {α}_{22} \qquad ( 44 )$$

Substituting into equation 40, we have

$${x}_{1} = {α}_{11} {ⅇ}^{{a}_{11} t} + \frac{{a}_{12}}{( {a}_{22 - {a}_{11}} )} {α}_{22} {ⅇ}^{{a}_{22} t} \qquad ( 45 )$$

This procedure is available for all input forms expected in a system comprising sets of first order differential equations.

An important result implied in equation 45 is that the form of the input x₂ is unchanging; the essence and immutability of each source element is therefore established. We seek ultimately to use this characteristic in further development of this invention.

Equally important in equation 45 are the constant coefficients. These coefficients are the basis for the auxiliary function [C] are a matrix of constants. This is a relief.

Including Inputs in the Set of Source Elements:

The source elements are the engines that drive the overall system. They also represents an interface with external entities by receiving and processing inputs. This section develops the solutions of the forced first order differential equations where the inputs (forcing functions) are applied at each discrete sample interval.

By way of review we realize the results of computations in a digital computer manifest only at discrete times, often referred to as sample times or computation times. They are generally arranged between constant time intervals. We may define the behavior of a system, or equations of state, in the time interval between the sample times; yet we may know its computed values only at the precise time of each sample time. For this reason we formulate our algorithms to conform to generalized sample intervals, and define time, r, as time between sample points tₙ and tₙ₊₁. At time tₙ, τ=0; at time tₙ₊₁, τ=δ, the sample interval length.

Consider inputs gₙ and gₙ₊₁ sampled at two computation times tₙ and tₙ₊₁ wherein the time between intervals is δ=tₙ₊₁−tₙ. Assuming a simple linear progression, a ramp with a slope ∈, from gₙ to gₙ₊₁ in the time interval, we formulate a simple expression representing an input and add the expression to the system of 36,
(s−a)x=gₙ+ετ (46)
where

$$ɛ = \frac{{g}_{n + 1} - {g}_{n}}{δ} \qquad ( 47 )$$

The general procedure in a linear domain is outlined in equations 35 to 45 above. According to linear theory, equation 46 is a valid input and should yield to a linear solution. However, the digital computer domain interrupts this procedure because the sample process disrupts the linearity of the input function at the sample points. In fact, the input occurring between sample points is unknown; the history of the input prior to the instant of sampling can generally only be inferred.

Implementation in the digital computer bypasses the input uncertainty by solving 46 in two stages; the first stage determines the value, or initial condition, at time t=tₙ. The formulation of the first stage excludes the term ∈ since it is undefined at this time. Then, in operational notation
(s−a)x=gₙ (48)
where s is the differential operator. The term gₙ indicates an initial condition; the term at any given sample point is generally the summation of all previous inputs.

By using The Method of Undetermined Coefficients we differentiate both sides of equation 46 to drive the right hand side to zero. Thus
s(s−a)x=s(gₙ)=0 (49)

This is a “new” homogeneous equation which, by inspection, has a solution of the form
x=αe^{aτ}+β (50)

The exponential term in 50 is the same as in equation 36, i.e. the unforced solution; consequently β must the particular solution responsive to the input Gₙ. We insert the particular solution into equation 46 to determine the value of β. Then, maintaining the equality, we have
(s−a)(β)=gₙ (51)

$$β = \frac{{g}_{n}}{a} \qquad ( 52 )$$

$$Then x = α {ⅇ}^{aτ} - \frac{{g}_{n}}{a} \qquad ( 53 )$$

We next include the ramp input ∈ by repeating the operational solution process above and get

$$x = α {ⅇ}^{aτ} - \frac{{G}_{n}}{a} - \frac{ɛ}{a} τ \qquad ( 54 )$$

Equation 54 is the solution of a single first order differential equation in the time following tₙ. The solution at the end of the computation interval, when time equals tₙ₊₁ and τ=δ is

$${x}_{n + 1} = α {ⅇ}^{a δ} - \frac{{G}_{n}}{a} - \frac{Δ}{a} \qquad ( 55 )$$

where
Δ=gₙ₊₁−gₙ (56)
the differential input.
Requirements Imposed on the Interconnective Auxiliary Function

We reconstruct equation 34 to maintain continuity,
Xᵢ=[[Cᵢⱼ][e^{a}^{_{iiτ}}]]X0ᵢ (57)

In order to determine the function [Cij] we first seek the derivative of X involving [Cij].

By trickery we first take the logarithms of both side of equation 57, and then take the derivative of each logarithm term. We get

$$\frac{\dot{X}}{X} = \frac{[ {\dot{C}}_{ij} ]}{[ {C}_{ij} ]} + \frac{{a}_{ii} {ⅇ}^{{a}_{ii} τ}}{{ⅇ}^{{a}_{ii} τ}} \qquad ( 58 )$$

or
\dot{X}=[[\dot{C}ᵢⱼ][Cᵢⱼ]⁻¹+aᵢᵢ]X (59)

We wish to establish a value of [Cᵢⱼ] as used in 57 by substituting 30 into 59. Then
[A−a]=[\dot{C}ᵢⱼ][Cᵢⱼ]⁻¹ (60)

Equation 60 is an underlying principle which may be implemented with a variety of functions.

A First Auxiliary Function:

We assert we have an auxiliary function when [Cᵢⱼ] satisfies 60. Evaluation of equations 57 and 60 at time of τ=0 and 47 at time τ=δ will provide values for three polynomial terms in [Cᵢⱼ]. Let
[Cᵢⱼ]=[[C0ᵢⱼ]]+[C1ᵢⱼ]t +[C2ᵢⱼ]t² (61)

Equation 57 at time τ=0 shows that the first term in the polynomial, [Cᵢⱼ], must be the identity matrix, i.e
[C0ᵢⱼ]=[I] (62)

We now insert our chosen auxiliary function 61 into equation 60 in order to solve for the coefficient matrices C1, C2, etc.. We include the prior result from 62 and then
[[I]+[C1ᵢⱼ]t+[C2ᵢⱼ]t²][A−a]=[[C1ᵢⱼ]+[C2ᵢⱼ](2t)] (63)

For τ=0, we have the value of
[C1ᵢⱼ]=[A−a] (64)

Continuing now with τ=δ, we have
[[I]+[A−a]δ+[C2ᵢⱼ]δ²][A−a]=[[A−a]+[C2ᵢⱼ](2δ)] (65)
and

$$[ {C2}_{ij} ] = \frac{1}{( 2 - δ )} [ A - a ] \qquad ( 66 )$$

Forming the auxiliary function 48 with the values isolated and inserting in 44 we have the final expression for an algorithm,

$${X}_{i} = [ [ [ I ] + δ [ A - a ] + {\frac{{δ}^{2}}{( 2 - δ )} [ A - a ]}^{2} ] [ {exp ( a δ )}_{ii} ] ] {X0}_{i} \qquad ( 67 )$$

The same process may be repeated with alternative formulations of [Cᵢⱼ]

A Fourth Embodiment

The fourth postulate, applied to a system of first order differential equations (DEs), enlarges on the previous postulates by choosing the differential state equation for each independent DE as the integratable auxiliary equation. The integrated auxiliary equation is next acquired as the solution to the differential state equation.

The integrated auxiliary equations are then evaluated at the computational sample interval yielding a set of algebraic equations for each DE. Final result of the system of differential equations are next obtained through simultaneous solutions of the set of algebraic equations.

We rely on the material under the third embodiment to support development of this embodiment, particularly equations 35 through 56.

Consider the system
\dot{X}=[A]X+Gₙ (68)
where the subscript n denotes an input to each element existing at the beginning of the computational interval. Expressed individually and in operational notation,
(s−a₁₁)x₁=0+a₁₂x₂+a₁₃x₃+g0₁
(s−a₂₂)x₂=a₂₁x₁+0+a₂₃x₃+g0₂
(s−a₃₃)x₃=a₃₁x₁+a₃₂x₂+0+g0₃ (69)

The following nomenclature, g0ᵢ and x0ᵢ, denotes values at the beginning of the computational interval, i.e. τ=0. Relying on the processes leading to equation 53 we find the diagonal elements of the solution; relying on the processes leading to equation 38 and 45 we reach the remaining elements. Then

$$\begin{matrix}{x}_{1} = {α}_{1} {ⅇ}^{{a}_{11} t} - \frac{{g}_{1}}{{a}_{11}} + \frac{{a}_{12}}{( {a}_{22} - {a}_{11} )} {α}_{2} {ⅇ}^{{a}_{22} t} + ( \frac{{a}_{12}}{{a}_{11}} ) ( \frac{{g}_{2}}{{a}_{22}} ) \\ {x}_{2} = \frac{{a}_{21}}{( {a}_{11} - {a}_{22} )} {α}_{1} {ⅇ}^{{a}_{22} t} + ( \frac{{a}_{21}}{{a}_{22}} ) ( \frac{{g}_{2}}{{a}_{22}} ) + {α}_{2} {ⅇ}^{{a}_{22} t} - \frac{{g}_{2}}{{a}_{22}}\end{matrix} \qquad ( 70 )$$

To solve for αᵢ we reorder equation 70. Using only the first two terms, we have

$$\begin{matrix}{α}_{1} + \frac{{a}_{12}}{( {a}_{22} - {a}_{11} )} {α}_{2} = {x0}_{1} + \frac{{g}_{1}}{{a}_{11}} - ( \frac{{a}_{21}}{{a}_{22}} ) ( \frac{{g}_{2}}{{a}_{22}} ) \\ \frac{{a}_{21}}{( {a}_{11} - {a}_{22} )} {α}_{1} + {α}_{2} = {x0}_{2} - ( \frac{{a}_{21}}{{a}_{22}} ) ( \frac{{g}_{1}}{{a}_{11}} ) + \frac{{g}_{2}}{{a}_{22}}\end{matrix} \qquad ( 71 )$$

Written in matrix form

$$[ \begin{matrix}1 & \frac{{a}_{12}}{( {a}_{22} - {a}_{11} )} \\ \frac{{a}_{21}}{( {a}_{11} - {a}_{22} )} & 1\end{matrix} ] ( \begin{matrix}{α}_{1} \\ {α}_{2}\end{matrix} ) = ( \begin{matrix}{x0}_{1} \\ {x0}_{2}\end{matrix} ) + [ \begin{matrix}1 & - ( \frac{{a}_{12}}{{a}_{11}} ) \\ - ( \frac{{a}_{21}}{{a}_{22}} ) & 1\end{matrix} ] ( \begin{matrix}( \frac{{g}_{1}}{{a}_{11}} ) \\ ( \frac{{g}_{2}}{{a}_{22}} )\end{matrix} ) \qquad ( 72 )$$

The right hand side of equation 72 reduces to a known column matrix. The terms a i are the unknown coefficients to the exponential terms of the solution. They are easily solved using for example a Gaussian elimination technique. Equation 72 reduces to

$$[ \begin{matrix}1 & 0 \\ 0 & 1\end{matrix} ] ( \begin{matrix}{α}_{1} \\ {α}_{2}\end{matrix} ) = ( \begin{matrix}{G}_{1} \\ {G}_{2}\end{matrix} ) \qquad ( 73 )$$

Here α₁=G₁. However, G₁ contains more than one component. To separate these components we repeat equation 53 where an input was identified. Then

$$x = {α}_{1} {ⅇ}^{α τ} - \frac{{g}_{n}}{a} \qquad ( 74 )$$

Satisfying the constraint of equality at τ=0, we have

$$x = ( x0 + \frac{{g}_{n}}{a} ) {ⅇ}^{aτ} - \frac{{g}_{n}}{a} \qquad ( 74 )$$

Inserting G₁ and converting to a form of 74.
xᵢ=(x0₁+(G₁−x0ᵢ))e^{aτ}−(G₁−x0ₗ) (75)
or
x₁=x0₁e^{aτ}+(e^{aτ}−1)(G₁−x0₁) (76)
or

The remaining state variables xᵢ are similarly calculated. The result for the connected system follows the equations 70.

### On Usefulness

Derivation of functions above have made postulates as well as mathematical constructs in deriving the several embodiments of the invention. No attempts has been made to prove any mathematical manipulations. This is left to mathematicians. Rather, the merit of the invention, and therefore its usefulness in a patent sense, is in stead verified by computer comparisons with computer implementation of prior art.

Computer Implementation:

The computer program implementing this invention and supporting the description of this invention is written in a simple QBASIC programming language. The following program was used to implement equation 28 of the second embodiment.

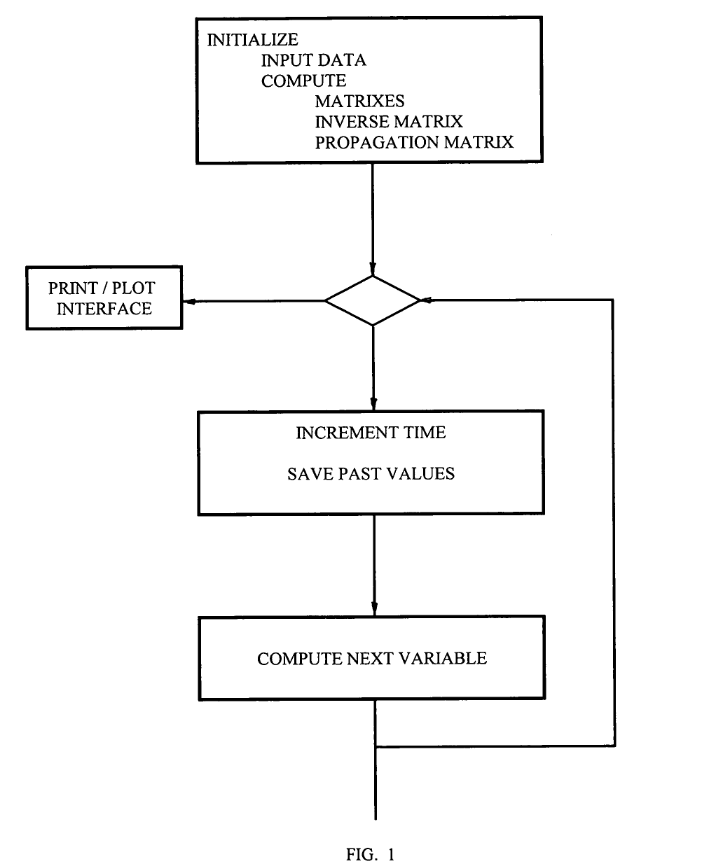

FIG. 1 represents a flow diagram of a computer program implementation of this invention.

The first block represent initialization of the program; the main task is the computation of a propagation matrix [M] as used in replacement statements 23 or 29 supra.

The diamond represents an initial entry point into the main program. It also serves as an entry point for repeated execution of replacement statements as the program loops with each added time increments. Finally, it serves to exit and to halt program execution when allotted time expires.

The next block increments time and stores and saves past values of the state variables.

The last block represents computer replacement statements performing computations as represented by replacement statements 21 and 27.

The exit block represents data saving tasks, data plotting, and other interface functions.

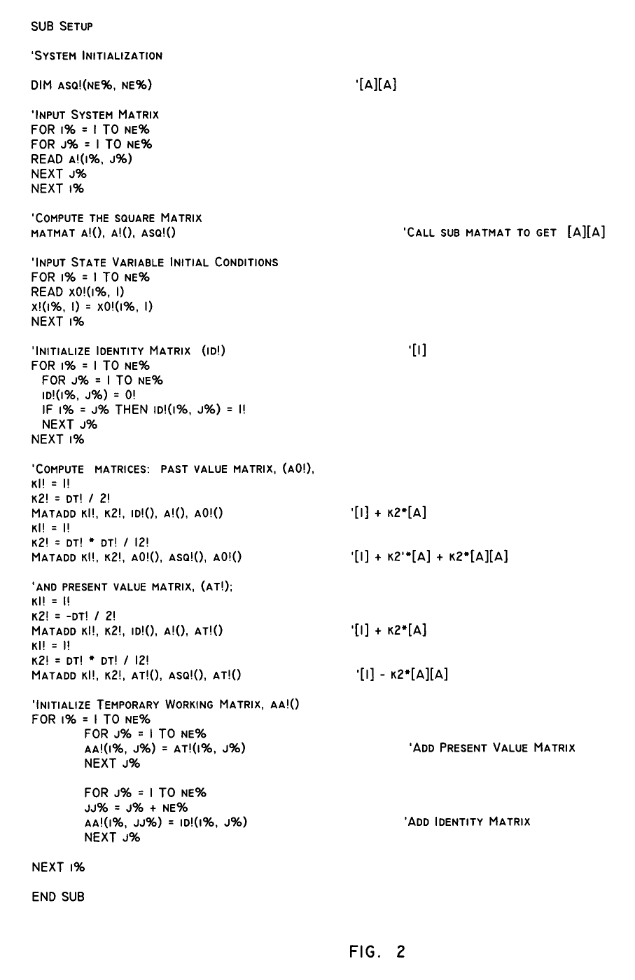

FIG. 2 represents a listing of a computer program, labeled SUB Setup. It provides for data inputs comprising the system matrix [A] and the initial values for the state variables X. The system matrix [A] is represented by a!(i %, j %),; the initial values of state variables Xₙ are represented as X0!(i %, 1). The X0!( ) subscripted variables also represent saved past values.

The subroutine performs a matrix multiplication, [A][A], identified with the comment statement “‘Compute the square Matrix”, and obtains the square of the matrix for use in computing the two matrices derived in expression 26-28 supra. The matmat statement denotes a call to a subroutine for matrix multiplication; it is a standard program in the art and is not listed in this application.

The program next accepts data denoting initial values of the state variables x0! and x! and initialize the identity matrix id! ( ).

Following the comment statement “‘Compute matrices: past value matrix, (a0!); , the program computes the right hand matrix of algorithm 27 supra. The matrix is labeled a0!( ). Matadd denotes a subroutine for matrix addition. It is not shown in this application.

Following the comment statement “‘and present value matrix, (at! ( )” the program computes the left hand matrix as shown in algorithm 27 supra. The matrix is labeled at!( ).

Lastly, the subroutine initialize a temporary working matrix aa!( ) used subsequently to compute the inverse of a target matrix.

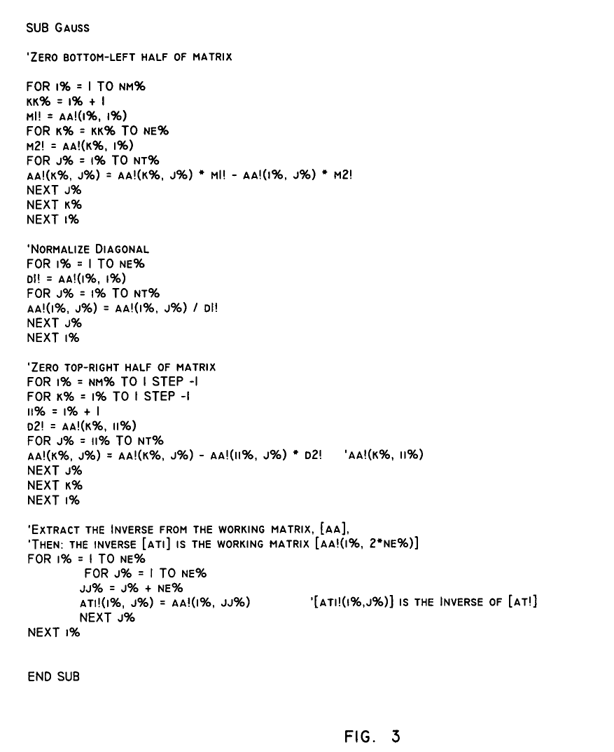

FIG. 3 lists a computer program labeled SUB Gauss. This subroutine computes the matrix inverse via a modified Gaussian elimination method. This method is part of this invention and is treated in more depth in a subsequent section.

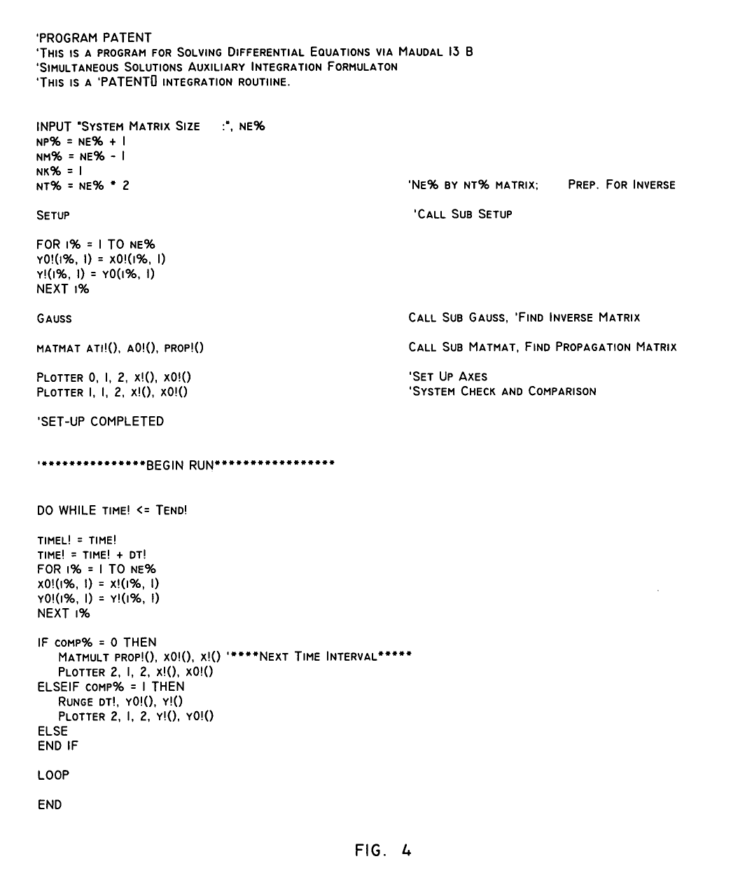

FIG. 4 are excerpts from a listings of the main computer program. The usual defining statements such as Dimension and Common statements and the like are not shown since these are standard elements of any program written in QBASIC language.

The first excerpts provides for input defining the size of the system matrix and, upon return from setup, defines indices used in later matrix manipulations.

The next excerpt begins with the initialization call to subroutine Setup. Upon return, the program sets the Runge-Kutta variables y0! and y! to the initial values of x0! and x! of this invention. Thus, with the same initial values, a comparison between the two methods is available.

The program then calls subroutine Gauss and returns with the left and right matrices, at!( ) and a0!( ) respectively, computed in setup as defined in algorithm 27 supra. Following the return from subroutine Gauss, the program calls subroutine Matmat. The return provides the matrix prop!( ), equivalent to the matrix [M] in replacement statement 27 supra.

Initialization, or set-up, is now complete.

The “Begin Run” comment statement announces the repetitive numerical computation segment of the program. The segment is a program loop and follow the outline shown in FIG. 1.

The loop saves and stores past computational values. The program then calls subroutine Matmult to compute the values of the state variables at the next time interval. The algorithm is a simple matrix multiplication of the past state variable, a column matrix, with the propagation matrix , a square matrix.

Epilogue

Specific inventions and embodiments have been described above. It is intended that this invention not be limited to the specific embodiments described, but should include the underlying concepts and methods implicit in the embodiments.

Specifically, embodiments incorporating the principles of immutability of source elements and exponentials is envisioned for continuing engineering efforts. The principles are outlined in equations 35 to 45 on pages 18 to 1 supra.

1. An improvement on an Euler type discrete integration method of a solution of a first order differential equation X′=a X, the improvements comprising:
including an unknown value of X in the formulation of the discrete integration, thus
Xₙ₊₁=Xₙ+δ(aXₙ₊₁) ,
and
solving the algebraic equation for the unknown variable, thus
Xₙ₊₁=Xₙ/(1−δa).

2. A further improvement over claim 1 whereby:
the Euler integration includes the average sum of a past and future value of X, thus
Xₙ₊₁=Xₙ+δa(Xₙ+Xₙ₊₁)/2,
and
solving the algebraic equation for the unknown value, thus
Xₙ₊₁32 Xₙ(1+δa2)/(1−δa/2).

3. In discrete algorithms for solving first order differential equations X′=a X in a digital computer with discrete computation intervals, where integration algorithms rely on known values of state variables to compute future unknown values of the state variables, improvements comprising:
a linear auxiliary function of time existing within and at the boundaries of the computation interval, the auxiliary function having identifiable parameters facilitating integration,
an integrated auxiliary function of time resulting from integration of the auxiliary function,
the parameters of both auxiliary functions evaluated against the parameters of the original differential equation, the functions incorporating both past and future values via evaluations at both boundaries of the computation interval, and
the final future value obtained by evaluating the integrated auxiliary function at the last boundary of the integration interval, thereby achieving accurate future result in a single computation interval.

4. A further improvement in claim 3 whereby:
parameters of the auxiliary functions generate polynomial function.

5. An extension of claim 3 to a system of differential equations by
defining the parameters of the auxiliary equations in matrix form.

6. In a digital computer solution of a set of first order differential equations an improved algorithm comprising the steps of:
initially isolating each differential equation from the set of homogeneous differential equations into elements,
obtaining source exponents, the source exponents being complementary solutions of each individual element, the source exponents being simple exponential terms multiplied by undetermined coefficient, the source exponent providing inputs to other elements,
obtaining auxiliary equations selected as an elements having source components as inputs from other elements, the auxiliary equations being non-homogeneous,
obtaining integrated auxiliary equations as the solution of the individual auxiliary equations,
obtaining a set of independent algebraic equations by entering the boundary values into the independent integrated auxiliary equations, the algebraic equations containing the undetermined coefficients of the source exponents,
determining the final coefficients to the source components by effecting a simultaneous solution of the set of independent algebraic equations,
obtaining a solution for the set of differential equations by substituting the final coefficient into the integrated auxiliary equations.
